(19) United States
(12) Patent Application Publication
(10) Pub. No.: US 2015/0276548 A1
(43) Pub. Date: Oct. 1, 2015

(54) CONDITION MONITORING AND ANALYTICS FOR MACHINES

(71) Applicants: THE REGENTS OF THE UNIVERSITY OF CALIFORNIA, Oakland, CA (US); SOLAR TURBINES INCORPORATED, San Diego, CA (US)

(72) Inventors: Chad M. Holcomb, San Diego, CA (US); Robert Ronald Bitmead, San Diego, CA (US); Raymond Arnoud de Callafon, San Diego, CA (US)

(73) Assignees: THE REGENTS OF THE UNIVERSITY OF CALIFORNIA, Oakland, CA (US); SOLAR TURBINES INCORPORATED, San Diego, CA (US)

(21) Appl. No.: 14/242,583

(22) Filed: Apr. 1, 2014

(51) Int. Cl. G01M 13/00; G01M 15/14

(52) U.S. Cl. CPC G01M 13/00; G01M 15/14

(57) ABSTRACT

A method for monitoring a condition of an actuator for a machine using a closed loop Hammerstein model structure is disclosed. The method includes receiving measured data for the machine and determining an actuator command associated with the measured data. The method also includes identifying a current static nonlinearity using one or more linear regression techniques, where the static nonlinearity is modeled between a known actuator and a linear plant of the machine. The method further includes determining whether the condition of the actuator has changed by comparing a resultant from identifying the current static nonlinearity with information of the known actuator.

### TECHNICAL FIELD

The present disclosure generally pertains to machines, and is more particularly directed toward a condition monitoring and analytics of actuators for machines.

### BACKGROUND

The operating conditions of machines, such as gas turbine engines, result in damage, degradation, and other faults occurring to or within the various components of the machines. Processes and systems for detecting the damage and degradation within components of machines are used to detect these faults and prevent unsafe operation of the machines.

U.S. Pat. No. 7,729,789 to T. Blevins is directed to systems and methods for on-line monitoring of operation of a process in connection with process measurements indicative of the operation of the process. In some cases, the operation of the process is simulated to generate model data indicative of a simulated representation of the operation of the process and based on the process measurements. A multivariate statistical analysis of the operation of the process is implemented based on the model data and the process measurements. The output data from the multivariate statistical analysis may then be evaluated during the operation of the process to enable the on-line monitoring of the process involving, for instance, fault detection via classification analysis of the output data.

The present disclosure is directed toward overcoming one or more of the problems discovered by the inventors or that is known in the art.

### SUMMARY OF THE DISCLOSURE

In one embodiment, the present disclosure is directed to a method for monitoring a condition of an actuator for a machine using a closed loop Hammerstein model structure. The method includes receiving measured data for the machine and determining an actuator command associated with the measured data. The method also includes identifying a current static nonlinearity using one or more linear regression techniques, where the static nonlinearity is modeled between a known actuator and a linear plant of the machine. The method further includes determining whether the condition of the actuator has changed by comparing a resultant from identifying the current static nonlinearity with information of the known actuator.

### BRIEF DESCRIPTION OF THE DRAWINGS

FIG. 1 is a schematic illustration of an exemplary machine.

FIG. 2 is a schematic illustration of the control signals sent and received by the control system of the gas turbine engine of FIG. 1.

FIG. 3 is a schematic illustration of a model structure for a machine, such as the gas turbine engine of FIG. 1.

FIG. 4 is a schematic illustration of a closed loop Hammerstein model structure of the machine modeled in FIG. 3.

FIG. 5 is a functional block diagram of the condition monitoring system of a machine, such as the gas turbine engine of FIG. 1.

FIG. 6 is a flowchart of a process for detecting a fault in an actuator of a machine, such as the gas turbine engine of FIG. 1.

### DETAILED DESCRIPTION

The systems and methods disclosed herein include an exemplary machine and a system for detecting an actuator fault from data collected in closed loop operation of a non-linear machine. The systems and methods estimate a parametrized nonlinear map in the series connection of a (partially) known actuator model and nonlinear machine model. The nonlinear machine model, such as a gas turbine, is comprised of a static nonlinear map and linear dynamic model. The identification of local distortions in the identified nonlinear map from the comparison of successive sets of batch data is correlated with degradation or faults in the actuator. The estimation procedure uses an overdetermined parameter vector to simultaneously identify the nonlinear map and linear dynamic machine model to make the estimation procedure pseudo-linear. The overdetermined parameter vector enables the application of linear regression techniques in the fault determination. Fault detection using an overdetermined estimation of a nonlinear map between a known actuator model and a linear plant model may require as little as two input signals, such as the speed of a rotary shaft and the command sent to an actuator of the machine.

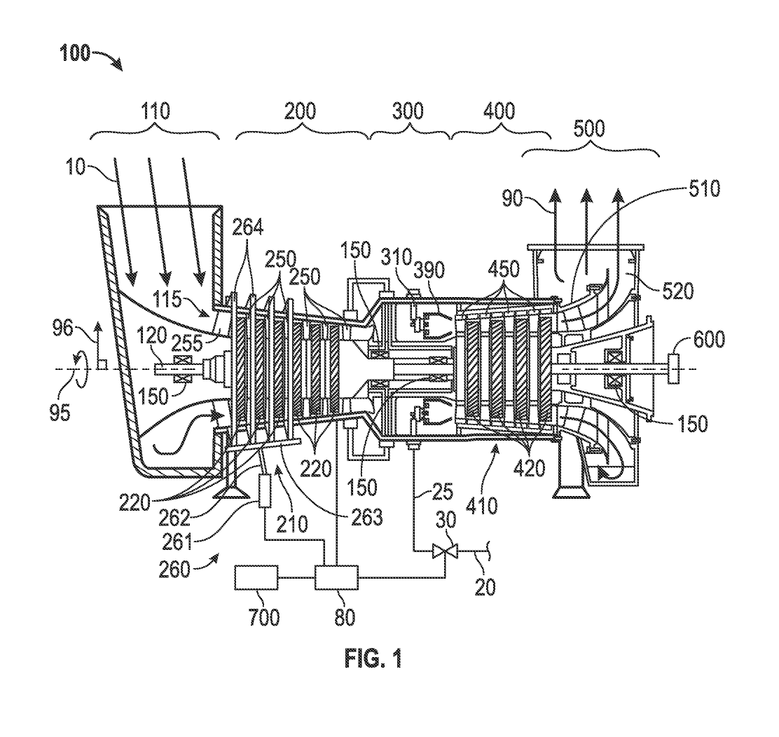

FIG. 1 is a schematic illustration of an exemplary machine. As illustrated, the machine is a gas turbine engine 100. The gas turbine engine 100 depicted in FIG. 1 is merely exemplary in nature and is not intended to limit the invention or the application and uses of the invention. The machine in accordance with this disclosure may be any machine including an actuation system connected to a controller.

Referring to FIG. 1, some of the surfaces have been left out or exaggerated (here and in other figures) for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of its shaft 120 (supported by a plurality of bearing assemblies 150). The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from, wherein a radial 96 may be in any direction perpendicular and radiating outward from center axis 95.

A gas turbine engine 100 may include an inlet 110, a shaft 120, a compressor 200, a combustor 300, a turbine 400, an exhaust 500, a power output coupling 600, a control system 80, and a condition monitoring system 700. The gas turbine engine 100 may have a single shaft or a multiple shaft configuration.

The compressor 200 includes a compressor rotor assembly 210, compressor stationary vanes (stators) 250, and inlet guide vanes 255. The compressor rotor assembly 210 mechanically couples to shaft 120. As illustrated, the compressor rotor assembly 210 is an axial flow rotor assembly. The compressor rotor assembly 210 includes one or more compressor disk assemblies 220. Each compressor disk assembly 220 includes a compressor rotor disk that is circumferentially populated with compressor rotor blades. Stators 250 axially follow each of the compressor disk assemblies 220. Each compressor disk assembly 220 paired with the adjacent stators 250 that follow the compressor disk assembly 220 is considered a compressor stage. Compressor 200 includes multiple compressor stages.

Inlet guide vanes 255 axially precede the fixed compressor stages. The inlet guide vanes 255 may be actuated variable guide vanes (VGV). Inlet guide vanes 255 may each be rotated about the axis of the inlet guide vane 255. Along with the inlet guide vanes 255, the first few stages of stators 250 may also be VGVs. In the embodiment illustrated, compressor 200 includes three stages of stators 250 that include VGVs located axially aft of inlet guide vanes 255, the three stages of stators being the first three stages of compressor 200.

VGVs may be rotated to modify or control the inlet flow area of the compressor 200 by an actuation system 260. Actuation system includes a VGV actuator 261, an actuator arm 262, and a linkage system 263. VGV actuator 261 moves actuator arm 262 that moves or translates the components of the linkage system 263. The linkage system includes linkage arms 264. A linkage arm may be connected to each inlet guide vane 255 and each stator 250 variable guide vane. When actuator arm 262 is moved it causes each linkage arm 264 to be moved and rotate each inlet guide vane 255 and each stator 250 variable guide vane. The VGV actuator 261, actuator arm 262, and linkage arms 264 may be coupled together and configured to rotate each VGV the same amount.

The combustor 300 includes one or more fuel injectors 310 and includes one or more combustion chambers 390. The fuel injectors 310 may be annularly arranged about center axis 95. One or more fuel supply lines 25 is connected to each fuel injector 310. The amount of fuel delivered to each fuel injector is determined by a fuel control valve 30. A fuel source line provides fuel to the fuel control valve 30.

The turbine 400 includes a turbine rotor assembly 410 and turbine nozzles 450. The turbine rotor assembly 410 mechanically couples to the shaft 120. As illustrated, the turbine rotor assembly 410 is an axial flow rotor assembly. The turbine rotor assembly 410 includes one or more turbine disk assemblies 420. Each turbine disk assembly 420 includes a turbine disk that is circumferentially populated with single crystal turbine blades 430. Turbine nozzles 450 axially precede each of the turbine disk assemblies 420. Each turbine disk assembly 420 paired with the adjacent turbine nozzles 450 that precede the turbine disk assembly 420 is considered a turbine stage. Turbine 400 includes multiple turbine stages.

The exhaust 500 includes an exhaust diffuser 510 and an exhaust collector 520. A power output coupling 600 may be located at an end of shaft 120.

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as alloy x, WASPALOY, RENE alloys, alloy 188, alloy 230, INCOLOY, MP98T, TMS alloys, CMSX single crystal alloys, and exquiax alloy.

Control system 80 may be electronically coupled to various actuators of the gas turbine engine 100, such as fuel control valve(s) 30 and VGV actuator 261. Control system 80 may also be configured to obtain various measurements/signals representing measurements from the gas turbine engine 100, such as pressures, temperatures, flows, and speeds including the rotational speed of the shaft 120. Control system 80 may be electronically coupled to various sensors, such as pressure, temperature, flow, and speed sensors to obtain this information. Control system 80 may include an electronic control circuit having a central processing unit (“CPU”), such as a processor, or micro controller. Alternatively, control system 80 may include programmable logic controllers or field-programmable gate arrays. Control system 80 may also include memory for storing computer executable instructions, which may be executed by the CPU. The memory may further store data related to controlling the actuators of the gas turbine engine including the fuel control valves 30 and the inlet guide vanes 255. Control system 80 also includes inputs and outputs to receive sensor signals and send control signals.

Condition monitoring system 700 may be electronically coupled to control system 80 and/or any number of the sensors located within the gas turbine engine 100. Condition monitoring system 700 may include an electronic control circuit having a central processing unit (“CPU”), such as a processor, or micro controller. Alternatively, condition monitoring system 700 may include programmable logic controllers or field-programmable gate arrays. Condition monitoring system 700 may also include memory for storing computer executable instructions, which may be executed by the CPU. The memory may further store data related to detecting a fault in the actuators of the gas turbine engine including the fuel control valve(s) 30 and the VGV actuator 261. Condition monitoring system 700 may also include inputs and outputs to receive sensor signals and control signals, and to send fault detection signals.

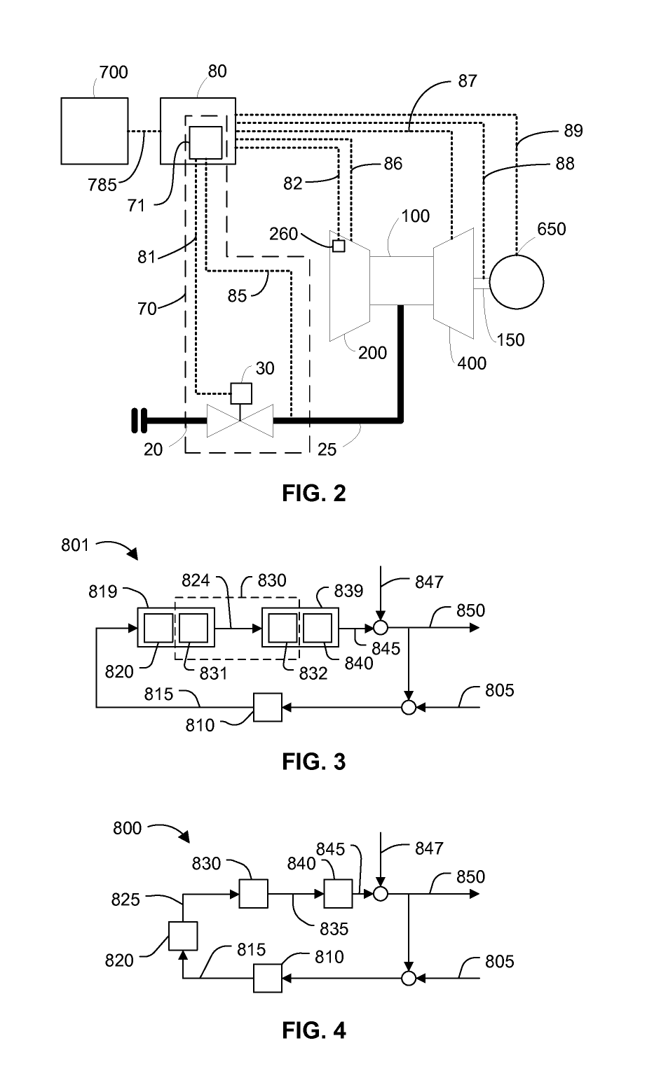

FIG. 2 is a schematic illustration of the control signals sent and received by the control system 80 of the gas turbine engine 100 of FIG. 1. Control system 80 may send control signals 81 and 82 to the fuel control valve 30 and to the VGV actuation system 260 to control the variable guide vanes, such as the inlet guide vanes 255. Control system 80 may control the set point of the actuators, such as fuel control valve 30 and VGV actuation system 260, through control signals, such as control signals 81 and 82.

Control system 80 may receive sensor signals 85, 86, 87, 88, and 89 from various components of the gas turbine engine 100. Sensor signal 85 may be the pressure of the fuel being supplied to the gas turbine engine 100 through fuel supply line 25. Sensor signal 86 may be the discharge air pressure of compressor 200. Sensor signal 87 may be the temperature of one or more stages of turbine 400. Sensor signal 88 may be the speed of shaft 120. Sensor signal 89 may be the output of a driven apparatus 650 coupled to shaft 120, such as the power output of a generator.

Control system 80 may use any combination of control signals and sensor signals to implement digital feedback control loops, such as a fuel control loop. Control system 80 uses the sensor signals to regulate one or more actuators with at least partially known and often nonlinear input-output behavior, such as fuel control valve(s) 30 and VGV actuation system 260. For example, control system 80 may use measurements of the speed of shaft 120, the temperatures of the stages of turbine 400, the pressure of the fuel being supplied to the gas turbine engine 100 through fuel supply line 25, and the discharge air pressure of compressor 200 to regulate the fuel flow through fuel control valve 30.

Control system 80 may include a fuel control 71. Fuel control 71 and one or more fuel control valves 30 may form a fuel system 70. Control signal 81 and sensor signal 85 may be a part of the fuel control loop of fuel system 70, along with sensor signal 88.

Condition monitoring system 700 may receive gas turbine engine data (“GTE data”) 785 from control system 80 or directly from sensors coupled to gas turbine engine 100. GTE data 785 may include any combination of control signals and sensor signals. In one embodiment, GTE data 785 includes the speed of shaft 120 and the control signal 81 to the fuel control valve 30.

Condition monitoring system 700 detects changes in the condition, such as fault/faults, in a non-linearly controlled actuator of a machine, such as the gas turbine engine 100 as illustrated in FIG. 2 by modeling the actuator and the machine in series. A model may be a mathematical representation of the characteristics and behaviors of a given system, such as the gas turbine engine or an actuator, or a relationship between two or more systems. FIG. 3 is a schematic illustration of a model structure 801 for a machine, such as the gas turbine engine 100 of FIG. 1. The model structure 801 includes a controller 810, an actuator 819, and a machine 839.

The controller 810 may be the control system 80, a model of the control system 80 or a model of the portion of the control system 80 that controls the actuator 819. The actuator 819 may be modeled as a known actuator 820, such as an uncontaminated, undamaged actuator, and an actuator error 831. The actuator error 831 is unknown within the model. The actuator error 831 may be the result of damage or contamination to the actuator 819. The actuator output 824 may be a determination of a characteristic of the actuator. For example, in some embodiments where the actuator 819 is a fuel control valve, the actuator output 824 represents the effective flow area of the actuator 819 and the actuator error 831 may represent contamination, such as sulfur contamination blocking the flow area of the actuator 819. The actuator output 824 may be modeled as:

x(t)=f(u(t))

where x(t) is the actuator output 824, u(t) is the actuator input 815, and f(·) is the actuator 819.

The known actuator 820 may be defined as a known, monotonic function. The knowledge of the known actuator 820 and its characteristics, such as the effective flow area, may be provided by the manufacturer, may be determined or measured through testing, or may be obtained by other means.

The machine 839 may be modeled as a Hammerstein model, a model with a non-linear function 832 and a linear plant 840 in series. The non-linear function 832 is an unknown memory-less function and the linear plant 840 is a time invariant dynamic plant. The linear plant 840 may model the machine or a sub-system of the machine, and in particular may model the relationship between the flow through the actuator/actuated system, such as fuel flow through a fuel control valve, and the measured system output 850.

The actuator error 831 and the non-linear function 832 may be modeled together as a static nonlinearity 830 to jointly caμure the nonlinear characteristics of the series connection of the actuator and the gas turbine engine linear plant 840.

The reference input 805 to the model structure 801 may be the measured data of the machine measured by one or more sensors during operation of the machine and may be obtained via one of the sensor signals 85-89. In one embodiment, reference input 805 provides the speed of shaft 120 of gas turbine engine 100. The actuator command (controller output) 815 may be the input to the actuator 819. Actuator command 815 may also be an available signal. In one embodiment, the actuator command 815 is received from control system 80. The actuator command 815 may be expressed as:

u(t)=K(q)(r(t)−y(t))

where u(t) is the actuator command 815, K (q) is the known controller 810, r(t) is the reference input 805, and y(t) is the measured system output 850. The system output 850 may be defined as:

y(t)=g(x(t))+v(t)

where y(t) is the system output 850, g(x(t)) is the machine output 845, and v(t) is noise 847. For the purposes of this discussion, noise 847 will be assumed to be a zero mean sequence and is assumed to be negligible. The system output 850 and the machine output 845 will therefore be assumed to be equal.

FIG. 4 is a schematic illustration of a Hammerstein model structure 800 of the machine. The Hammerstein model structure represents the machine operations in a closed loop that contains information of the known controller 810, the known actuator 820, the static nonlinearity 830 and the linear plant 840 in series as described in reference to FIG. 3. The linear plant 840 is a function of the parameters to be identified.

Along with the reference input 805 and the actuator command 815, the Hammerstein model structure 800 may also include a known actuator output 825 and a linear plant input 835. The known actuator output 825 represents the output of the known actuator 820 and is the input to the static nonlinearity 830. The linear plant input 835 represents the fictitious signal from the static nonlinearity 830 to the linear plant 840.

The non-linear relationship between the known actuator output 825 and the linear plant input 835 are written as the sum of orthogonal basis functions to produce a linear parametrization of the prediction error. An orthogonal set of bases may be chosen that suitably enables fitting the nonlinearity, such as a Guassian, piecewise linear, or sigmoid basis functions. In the embodiment illustrated, the orthogonal basis function is a Guassian basis function. The Gaussian basis functions may facilitate an accurate approximation while using only a few parameters.

In the embodiment illustrated, the known actuator output 825 is expressed as the polynomial relation:

w(t)=Σ₁₌₀^{P}a₁u(t)′=f₀(u(t))

where w(t) is the known actuator output 825, a₁ is a known coefficient(s), u(t) is the actuator command 815, and P is the order of the polynomial. f₀(·) is the known actuator 820 and may be based on the characteristics of a nominal actuator. In the embodiment illustrated, the linear plant input 835 may be expressed as the sum:

x̅(t)=Σⱼ₌₁^{M}ρⱼ(w(t))μⱼ

where x̅(t) is the linear plant input 835, ρⱼ(w(t)) is a Guassian basis function with a fixed center mⱼ, and μ₁ is a weighting vector. The noise free system output 850 may be expressed as:

y(t)=G(q) x̅(t)

where y(t) is the system output 850, G (q) is the linear plant 840, and x̅(t) is the linear plant input 835 and v(t) neglected.

In practice, the entire range of the actuator command 815 and the known actuator output 825 cannot be excited due to operational constraints on the machine. The basis uses the grid m=[m₁ m_{M}]^{T} to define the center locations of the Gaussian basis functions based on the range of actuator command u(t), and calculated nominal actuator output w(t) contained in the dataset used for identification. The grid is dependent on the available data set and must satisfy [m(1)≦w(t)≦m(M)]∀tε[1,N]. The weighting vector μ=[μ₁ . . . μ_{M}]^{T} specifies the weights of the basis functions at the center locations defined by the grid vector m. The basis vector is defined as ρ(w(t))=[ρ(w(t)) . . . ρ_{M} (w(t)]^{T}, with the Gaussian radial basis functions grid node mⱼ defined as:

$${ρ}_{j} ( w ( t ) ) = \frac{1}{σ \sqrt{π}} exp ( ( \frac{- {( w ( t ) - {m}_{j} )}^{2}}{{σ}^{2}} )$$

where σ is the variance of a normal Gaussian distribution with the standard deviation defined as the variance squared. The linear plant input 835 can be defined in vector notation as:

x̅(t)=ρ^{T}(w(t))μ

The nonlinear relationship of the known actuator output 825 (w(t)) and the linear plant input 835 ( x̅(t)) is written as a sum of Gaussian basis functions ρⱼ(w(t)), with weights μⱼ and centers m₁ to produce a linear parameterization of the prediction error. The weighting vector μ that characterizes the static nonlinearity 830 in this basis, is the parameter of vector to be identified. The vectors ρ, μ, and m may be column vectors.

The dynamics of the linear plant 840 may be modeled using a rational linear time invariant system of two linear models and a known time delay t_{d}. One linear model is well parametrized of orders nₐ* and n_{b}*, and the other of orders nₐ and n_{b}. The known orders nₐ and n_{b} are high orders, while the known orders nₐ* and n_{b}* are low orders. The time delay is assumed to be greater than one time sample. A stacked plant parameter may be used to generate an estimate of the linear plant 840 defined as:

$$G ( q ) = {q}^{- {t}_{d}} \frac{B ( q )}{A ( q )}$$

where A(q)=1+a₁q⁻¹+ . . . +aₙ_{ₐ}q⁻ⁿ^{ₐ} and B(q)=b₀+b₁q⁻¹+ . . . +bₙ_{_{b}}q⁻ⁿ^{_{b}} where q⁻¹ is a delay operator.

Within a closed loop system, an estimate of the system output 850 may be given by:

$$\hat{y} ( t ) = \frac{B ( q , {θ}_{b} )}{A ( q , {θ}_{a} )} \hat{x} ( t - {t}_{d} )$$

where x̅(t) is the estimate of the linear plant input 835 and:

θₐ=[a₁ . . . aₙ_{ₐ}]^{T},ε [symbol] ⁿ^{ₐ}^{×1}

θ_{b}=[b₀ . . . bₙ_{_{b}}]^{T},ε [symbol] ⁿ^{_{b}}^{1×1}

The parameter θ to be identified is overparametrized and is associated with the overdetermined model of orders nₐ and n_{b}. This overparametrization makes the estimation a pseudo-linear optimization problem allowing iterative linear regression techniques to be applied. The estimate of the system output 850 includes a linear combination of past values of ρ^{T} (ŵ(t−t_{d}))μ filtered by B(q, θ_{b}) and can be written in terms of a linear combination of a parameter dependent regressor and an augmented, non-minimal parameter vector as:

\hat{y}(t,θ)=φ^{T}(t,θ)θ

where φ(t,θ) is the parameter dependent regressor. The parameter θ and the parameter dependent regressor vectors are defined as:

$$θ = [ \begin{matrix}{θ}_{a} \\ {θ}_{{b}_{μ}}\end{matrix} ] and {ϕ}^{T} ( t , θ ) = [ \begin{matrix}{ϕ}_{a} ( t , θ ) \\ {ϕ}_{{b}_{μ}} ( t , θ )\end{matrix} ]$$

where φₐ(t, θ) ε [symbol] ⁿ^{ₐ}^{×1}, θ_{b}_{_{μ}}ε [symbol] ⁿ^{_{b}}^{+1)M×1}, and φ_{b}_{_{μ}}(t, θ) ε [symbol] ⁽ⁿ^{_{b}}^{+1)M×1} and the elements of the parameter θ and the parameter dependent noise free data regressor vectors are given by:

θ_{b}_{_{μ}}=[b₀μ^{T} . . . bₙ_{_{b}}μ^{T}]^{T}

φₐ(t,θ)=[−\hat{y}(t−1) . . . −\hat{y}(t−nₐ)]^{T}

φ_{b}_{_{μ}}(t,θ)=[ρ^{T}(\hat{w}(t−t_{d})) . . . ρ^{T}(\hat{w}(t−t_{d}−n_{b}))]^{T}

An element of the non-minimal parameter θ_{b}_{_{μ}} may be decomposed by normalizing an element of the stacked plant parameter, such as ∥bᵢ|₂, or an element of the weighting vector, such as ∥μⱼ|, to 1 and applying a singular value decomposition procedure to overcome overparametrization. An auxiliary parameter matrix may be defined as:

$$Γ {=}^{Δ} [ \begin{matrix}{b}_{0} {μ}_{1} & {b}_{0} {μ}_{2} & … & {b}_{0} {μ}_{M} \\ {b}_{1} {μ}_{1} & {b}_{1} {μ}_{2} & … & {b}_{1} {μ}_{M} \\ ⋮ & ⋮ & ⋱ & ⋮ \\ {b}_{{n}_{b}} {μ}_{1} & {b}_{{n}_{b}} {μ}_{2} & … & {b}_{{n}_{b}} {μ}_{M}\end{matrix} ] = b {μ}^{T} .$$

A construct of the auxiliary parameter matrix \hat{Γ}_{bμ}=blockvec(\hat{θ}_{bμ}) may be formed using an estimate for the element of the non-minimal parameter \hat{θ}_{b}_{_{μ}} and may be defined as:

$$\hat{Γ} = [ \begin{matrix}{\hat{θ}}_{{b}_{μ}}^{T} ( 1 \text{:} M ) \\ {\hat{θ}}_{{b}_{μ}}^{T} ( M + 1 \text{:} 2 M ) \\ ⋮ \\ {\hat{θ}}_{{b}_{μ}}^{T} ( {n}_{b} M + 1 \text{:} ( {n}_{b} + 1 ) M )\end{matrix} ] .$$

In this way, the system parameter vectors \hat{θ}_{b} and \hat{μ} may be obtained by minimizing

$$[ \hat{μ} , {\hat{θ}}_{b} ] = {argmin 〚 Γ - \hat{Γ} 〛}^{2}$$

$$\hat{μ} , {\hat{θ}}_{b}$$

Setting an initial value of \hat{b}₀=1 and μ₀=\hat{θ}_{b}_{_{μ}}^{T}(1: M) gives and an initial estimate of the static nonlinearity 830 as \hat{δ}(w(t)=ρ^{T} (w(t))\hat{μ}₀ and \hat{δ}₀( w̅)=ρ^{T}( w̅)\hat{μ}₀. The resultant matrix for M points {w₁ . . . w_{M}} within the range [m₁,m_{M}] may be defined as:

$$Ω = [ \begin{matrix}{ρ}_{1} ( {w}_{1} ) & … & {ρ}_{M} ( {w}_{1} ) \\ ⋮ & ⋱ & ⋮ \\ {ρ}_{1} ( {w}_{M} ) & … & {ρ}_{M} ( {w}_{M} )\end{matrix} ] ∈ {( M \times M )}^{} ,$$

and the estimate of the weighting vector may be defined as:

\hat{μ}=\hat{μ}−Ω⁻¹\hat{δ}₀( w̅).

The static nonlinearity 830 defined as δ(w(t))=ρ^{T} (w(t))\hat{μ} then satisfies the constraint the mean value of the static nonlinearity being equal to zero (δ₀( w̅(t))=0). A unique inverse of the resultant matrix is guaranteed to exist by construction as an orthogonal set of basis functions. b̅ᵢ is then corrected using \hat{μ}:

$${\hat{b}}_{i} = \frac{{\hat{μ}}^{T} \hat{Γ} ( i , : )}{{\hat{μ}}^{T} \hat{μ}} ,$$

where the i^{th} row of the construct of the auxiliary parameter matrix is \hat{Γ}(i,:).

Condition monitoring system 700 may be configured to determine an estimate for the non-minimal parameter θ using a prediction error minimization method and by minimizing the quadratic cost function. The prediction error minimization method may be used to estimate the weighting vector and the stacked plant parameter vector via the non-minimal parameter θ. For measurements of the actuator command 815 and the system output 850 and the non-minimal parameter, the prediction error is:

ε(t,θ)=y(t)−φ^{T}(t,θ)θ

In batch estimation, based on N data points:

Y=[y(1) . . . y(N)]^{T}

Φ^{T}(θ)=[φ^{T}(1,θ) . . . φ^{T}(N,θ)]

E(θ)=[Y−Φ^{T}(θ)θ]

An estimate of the non-minimal parameter based on N data points can be used to minimize the quadratic cost function. The quadratic cost function may be defined as:

$${V}_{OE}^{N} ( θ ) = \frac{1}{2 N} {\sum }_{t = 1}^{N} {ɛ}^{2} ( t , θ ) = \frac{1}{2 N} {E ( θ )}^{T} E ( θ ) ,$$

Where the estimate of the non-minimal parameter θ based on N data points is defined as

$${\hat{θ}}^{N} = {argmin}_{θ} {V}_{OE}^{N} ( θ )$$

While the prediction error is linear in the measurements, the regressor is dependent on the parameter θ, and the quadratic cost function represents a pseudo-linear minimization problem.

Condition monitoring system 700 may be configured to determine a high order initial estimate of the non-minimal parameter θ. The quadratic cost function may include multiple local minima. An initial estimate of the non-minimal parameter may be important to avoid error when using prediction error methods. For an initial estimate of both the linear plant 840 and the static nonlinearity 830, the orders of A(q, θₐ) and B(q, θ_{b}) may be increased in order to minimize the bias from the nonlinear distortions and unmodeled dynamics. With a small perturbation on the reference input 805, second and third order linear models (i.e. nₐ* & n_{b}*≦3) are able to capture the dominant machine dynamics. The initial estimate of the non-minimal parameter may be determined by setting the orders of the linear plant 840 in the initialization as nₐ=nₐ*+nₑ and n_{b}=n_{b}*+nₑ, where nₑ to create a high order \hat{θ}_{H} and regressor matrix. The initial estimate of the non-minimal parameter may be defined based on the regressor matrix Φθ_{H} as:

θ_{N}^{N}=[Φ(θ_{H})Φ(θ_{H})^{T}]⁻¹[Φ(θ_{H)}^{T}Y]

Condition monitoring system 700 may also be configured to determine new low order estimate of the non-minimal parameter. A set of estimates of the actuator command 815, the known actuator output 825, the linear plant input 835, and the system output 850 is generated with the initial estimate of \hat{θ}_{H}. A new parameter θ^{N} is estimated with a noise free regressor from pĥi(θ)_{H} using equation for \hat{θ}_{H}^{N}. A low order regressor matrix Φ_{L} of orders nₐ* and n_{b}* is then created and used to compute a new \hat{θ}₁^{N}. With \hat{θ}₁^{N}, a new estimate of the linear plant 840 is calculated of orders nₐ* and n_{b}*.

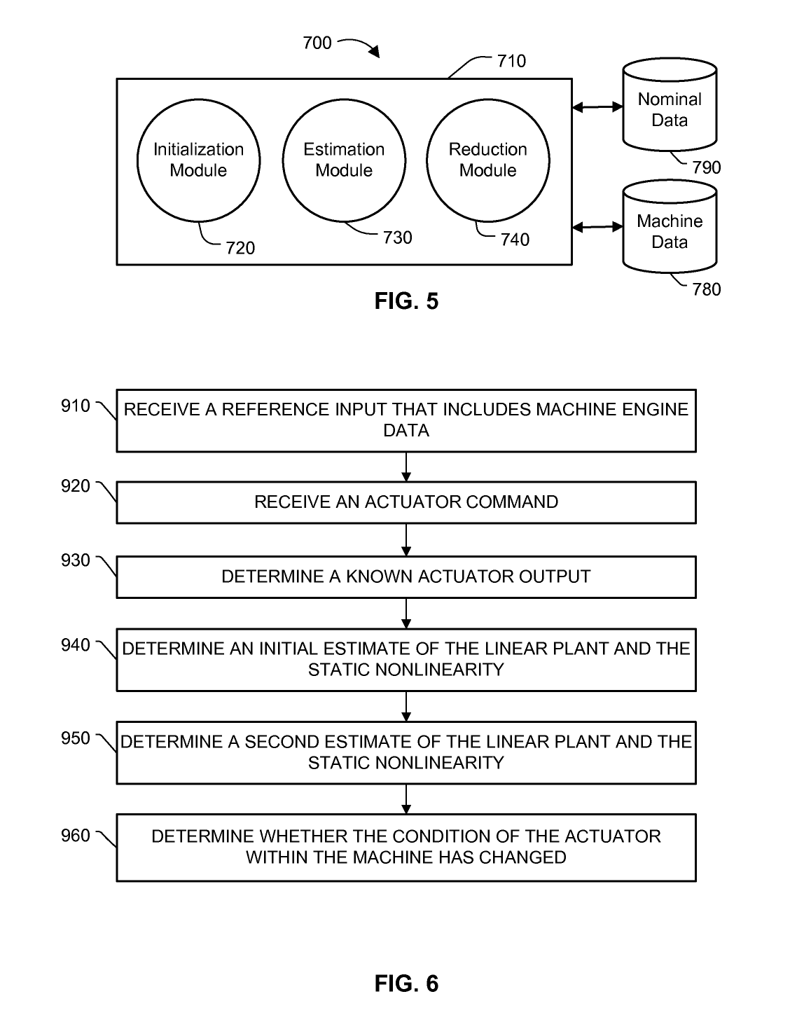

FIG. 5 is a functional block diagram of the condition monitoring system 700 for a machine, such as the gas turbine engine of FIG. 1. Condition monitoring system 700 may be implemented on a computer 710 or server that includes a processor for executing computer-software instructions, and a memory that can be used to store executable software program modules that can be executed by the processor. The memory includes a non-transitory computer readable medium used to store program instructions executable by the processor.

Condition monitoring system 700 may include an initialization module 720, an estimation module 730, and a reduction module 740. The initialization module 720 is configured to determine an initial estimate of the non-minimal parameter θ and of the static nonlinearity 830. The initial estimate of the non-minimal parameter θ may be determined by first by determining the known actuator output 825 and determining the high order regressor matrix based on the measurement data. The known actuator output 825 may be summation to the order of P of the actuator command 815 times known coefficients. The regressor matrix is determined using the known actuator output 825 and the system output 850 based on the number of data points provided in the batch.

Initialization module 720 may also be configured to determine an initial estimate of the linear plant 840, along with an initial estimate of the weighting vector μ of the Gaussian basis function vector.

The estimation module 730 is configured to determine noise free estimates of the actuator command 815, the known actuator output 825, and the system output 850 within the closed loop system based on turbine dynamics modeled using a linear error model structure. The gas turbine engine linear plant 840 is assumed to be a rotational linear time invariant system of known orders and a time delay greater than one time sample.

The reduction module 740 may be configured to determine a second estimate of the non-minimal parameter θ. The second estimate of the non-minimal parameter θ may be determined using a low order regressor matrix. The low order regressor matrix may be determined using the noise free estimates of the actuator command 815, the known actuator output 825, and the system output 850.

The reduction module 740 may also be configured to determine a low order estimate of the weighting vector μ, which may then be used to determine an estimate of the low order linear plant 840.

The reduction module 740 may also be configured to identify the static nonlinearity 830 and compare the results to those of a known actuator. The known actuator may be that of a nominal actuator or may be determined through testing, or by other means. Any deviations in the comparison may signify there is a fault in the actuator 819. Faults may also be signified by any deviations in the static nonlinearities 830 or the parameters θ and μ. For example, the nominal/known actuator may be an uncontaminated fuel control valve and the actuator of the machine may be fuel control valve 30 within gas turbine engine 100. Any deviations detected may signify that fuel control valve 30 is contaminated, or that conditions within the fuel control valve 30 have changed. The size of the deviation at any given operating set point may be mapped to the amount of contamination present within that portion of the fuel control valve 30.

A plot of the static nonlinearity of the actuator 819 and that of the known actuator may illustrate the deviations. The known actuator may be a nominal uncontaminated/undamaged actuator. As a nominal actuator may not include an actuator error 831, the static nonlinearity may represent the unknown non-linear function 832. Thus, any deviation from the static nonlinearity of the nominal actuator illustrates the actuator error 831 of the actuator 819.

The condition monitoring system 700 may also include a machine data store 780 and a nominal data store 790. Machine data store 780 may include data received from either the machine, such as gas turbine engine 100, or the control system 80, such as a batch of operating information. Each batch received may include the information from any of the command signals of the control system 80, such as an actuator command 815, and any of the sensor signals of the machine, such as the rotational speed of shaft 120 over a given time frame. The nominal data store 790 may include the known actuator characteristics, the known actuator static nonlinearity, and/or the historical data regarding the actuator determined using the condition monitoring system 700, such as previously determined values of the static nonlinearity 840 and estimates of the linear plant 840.

### INDUSTRIAL APPLICABILITY

Industrial machines, such as gas turbine engines, may be suited for any number of industrial applications such as the oil and gas industry (including transmission, gathering, storage, withdrawal, and lifting of oil and natural gas), the power generation industry, cogeneration, aerospace, and other transportation industries.

Referring to FIG. 1, for the general operation of gas turbine engine 100, a gas (typically air 10) enters the inlet 110 as a “working fluid”, and is compressed by the compressor section 200. In the compressor section 200, the working fluid is compressed in an annular flow path 115 by the series of compressor disk assemblies 220. In particular, the air 10 is compressed in numbered “stages”, the stages being associated with each compressor disk assembly 220. For example, “4th stage air” may be associated with the 4th compressor disk assembly 220 in the downstream or “aft” direction, going from the inlet 110 towards the exhaust 500. Likewise, each turbine disk assembly 420 may be associated with a numbered stage. The upstream stages of the compressor may include inlet guide vanes 255. The inlet guide vanes 255 may be actuated to control the amount of air 10 entering the compressor 200.

Once air 10 leaves the compressor section 200, it enters the diffuser and then combustor 300 and fuel is added by fuel injectors 310. Fuel control valves 30 may be actuated to control the amount of fuel added by fuel injectors 310. Compressed air 10 and fuel are injected into the combustion chamber 390 via injector 350 and combusted. Energy is extracted from the combustion reaction via the turbine section 400 by each stage of the series of turbine disk assemblies 420. Exhaust gas 90 may then be diffused in exhaust diffuser 510, collected and redirected. Exhaust gas 90 exits the system via an exhaust collector 520 and may be further processed (e.g., to reduce harmful emissions, and/or to recover heat from the exhaust gas 90).

During operation of gas turbine engine 100, actuators, such as fuel control valve 30 and VGV actuation system 260, may be damaged, degraded, contaminated, partially blocked, or may otherwise not perform as expected. Operating gas turbine engine 100 with actuators that are damaged or that are not performing as expected may result in further damage to the actuators, damage to other components of gas turbine engine 100, and may result in unsafe operation of gas turbine engine 100.

Condition monitoring system 700 may help determine whether an actuator is operating as expected, and whether or not a machine, such as gas turbine engine 100, should be shut down to repair/replace the damaged actuator. Condition monitoring system 700 may also be used to compensate for the modification in performance of the actuator.

FIG. 6 is a flowchart of a process for monitoring the condition of an actuator for a machine, such as the gas turbine engine 100 of FIG. 1. The method includes receiving a reference input 805 that includes machine data, such as measured data at step 910. The measured data may include the gas turbine engine data 785, such as the rotational speed of shaft 120, rotational speed of the cost producer, rotational speed of the power turbine, temperatures/pressures within the gas turbine engine 100, such as the temperature of the third stage turbine nozzle, and the power generated by an electric motor coupled to the gas turbine engine 100. The method also includes receiving an actuator command 815 associated with the reference input 805 at step 920. The actuator command 815 may be determined directly by the condition monitoring system 700 or may be received by the condition monitoring system 700 from the control system 80 that previously determined the actuator command 815. The condition monitoring system 700 may receive both the actuator input 805 and the actuator command 815 in batches of information. Each batch of information may be a collection of the actuator input 805 and the actuator command 815 over a predetermined time sample. Each batch of information may be obtained from recorded data sets of operational information for the machine.

The method may also include determining a known actuator output 825 at step 930. The known actuator output 825 may represent a known characteristic of the actuator, such as the effective flow area of the known actuator 820. The known actuator output 825 may be provided by the actuator manufacturer, may be determined through testing, or may be determined by other means. The known actuator output 825 may be a fictitious signal between the known actuator 820 and the static nonlinearity 830. The known actuator output 825 may be determined for the given time sample and included in the batch of information including the reference input 805 and the actuator command 815.

The method also includes identifying the static nonlinearity 830 (the static nonlinear relationship) between the actuator 819 and the machine. The static nonlinearity 830 may be identified by determining the parameters that define the linear plant 840 and the parameters that define the static nonlinearity 830. Steps 940 to 950 outline how the static nonlinearity 830 may be identified.

The method may further include determining an initial estimate of the linear plant 840 and the static nonlinearity 830 at step 840. These initial estimates may be estimates of the high order parameters that define the linear plant 840 and the static nonlinearity 830. The initial estimate may be determined using linear regression techniques. The linear regression techniques may be applied due to the non-minimal/overparametrization of θ. Step 940 may be based on the known actuator output 825, and may also be based on the reference input 805 and the actuator command 815.

The method may yet further include determining a second estimate of the linear plant 840 and the static nonlinearity 830 at step 950. The second estimates may be estimates of the low order parameters that define the linear plant 840 and the static nonlinearity 830. Step 950 may include generating noise free estimates of the actuator command 815, the known actuator output 825, and the system output 850 based on the closed loop model structure 800 and on the high order estimates of the parameters. Step 950 may also include identification of a data content dependent gain assignment that facilitates an informed decomposition to a linear plant 840 realization. Step 950 may further include a Gaussian basis function parametrization of the static nonlinearity, which may allow for an arbitrarily fine grid to construct analytical condition monitoring. Resultants from determining the second estimate of the linear plant 840 and the static nonlinearity 830 may include the various low order parameters that define the linear plant 840 and the static nonlinearity 830, the second estimate of the known actuator output 825, and the second estimate of the system output 850.

In embodiments, the high order parameters of the linear plant 840 and the static nonlinearity along with the associated computations may not be determined for every batch of information received. Similarly the low order parameters of the linear plant along with the associated computations may not be determined for every batch of information received. In these embodiments, the values of the parameters, and the first estimates of the linear plant 840 and the static nonlinearity 830, along with the low order linear plant 840 are assumed to be constant from the previous iteration of computations. The second estimate of the static nonlinearity 830, and the resulting parameter values are determined based on the assumed constants from the previous iteration. This may reduce computation times of the system.

In other embodiments, the estimates of the linear plant 840 and the associated calculations and parameters are updated at a predetermined interval, independent of the low order estimates of the static nonlinearity 830 and the associated calculations and parameters.

The method still further includes determining whether the condition of the actuator within the machine, such as gas turbine engine 100, has changed at step 960. Determining whether the condition of the actuator has changed may be based upon comparing a resultant from step 950 to a previously determined resultant of the actuator or comparing the resultant to a known actuator. For example, the second estimate of the static nonlinearity 830 may be compared to a previously determined second estimate of the static nonlinearity from a previous batch of information. A change in the condition of the actuator may signify a fault, damage, or other errors in the actuator.

The method may also include identifying the static nonlinearity for a known actuator prior to identifying the static nonlinearity of the actuator. Identifying the static nonlinearity for the known actuator may provide the resultant data needed for comparison purposes.

In one embodiment, the actuator is a fuel control valve 30 for the gas turbine engine 100, and the method is used to detect contamination of the fuel control valve 30 and to determine whether the effective flow area of the fuel control valve 30 has changed. The gas turbine engine linear plant 840 may be a model of the gas turbine engine system 100 or a subsystem, such as the fuel system 70. Fuel control valves 30 may become contaminated due to a buildup of sulfur deposits within fuel control valve 30. The sulfur deposits may modify the effective flow area of fuel control valve 30. The change in effective flow area and the sulfur deposition may be detected by a change in the known actuator output 825, the static nonlinearity 830, the gas turbine engine linear plant 840, or the low order estimates of the parameters that define the static nonlinearity 830 and the gas turbine engine linear plant 840.

In one embodiment, an identified low order parameter of the static nonlinearity 830 of the fuel control valve 30 is compared to a previously determined low order parameter of the static nonlinearity 830 of the fuel control valve 830. Any deviation in the parameter may signify a buildup in sulfur deposits and a change in the effective flow area of the fuel control valve 30. In another embodiment, the identified static nonlinearity 830 of the fuel control valve 30 is compared to the previously determined static nonlinearity 830 of the fuel control valve 30. The fuel control valve 30 may be monitored by comparing the static nonlinearity 830 of the fuel control valve 30 to the previously determined static nonlinearity 830 of the fuel control valve 30 at a predetermined interval.

A correlation between the static nonlinearity 830 and the effective flow area of the fuel control valve 30 may be developed, which may be used to correct for the contamination or to calibrate the fuel control valve 30 within the fuel system 70.

In another embodiment, the actuator is one or more inlet guide vanes 255. Comparison of the resultants may aid in airflow management, or in surge detection and control.

The process for monitoring the condition of an actuator for a machine may be performed at the location of the machine or may be performed remotely. The condition monitoring system 700 may be located locally or remotely to the machine. The condition monitoring system 700 may be used to remotely monitor and manage one or more machines, such as gas turbine engines, from a central location. The condition monitoring system 700 may be connected to the machine via one or more networks, a local area network (LAN), other types of network, or a combination thereof to obtain the field data of the machine.

The process for monitoring the condition of an actuator for a machine may be used by processes, methods, and systems of service for the machine. Such a process may use the fault detection to determine whether to replace a particular actuator of the machine, or to determine whether to perform or schedule service of the machine. Determining whether to perform or schedule service may depend on whether the machine can operate safely with the fault detected.

The processes and systems disclosed herein may be used on any number of actuators simultaneously, and in particular may be used for each actuator of a machine, such as gas turbine engine 100.

Those of skill will appreciate that the various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, block, or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor (e.g., of a computer), or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A method for monitoring a condition of an actuator for a machine using a closed loop model structure, the method comprising:
receiving measured data for the machine;
receiving an actuator command associated with the measured data;
identifying a current static nonlinearity with the closed loop model structure using one or more linear regression techniques, where the static nonlinearity is modeled between a known actuator and a linear plant of the machine; and
determining whether the condition of the actuator has changed by comparing a resultant from identifying the current static nonlinearity with a previous resultant from identifying a previous static nonlinearity of the actuator.

2. The method of claim 1, wherein the measured data is a rotational speed of a shaft of the machine.

3. The method of claim 1, wherein the measured data and the actuator command associated with the measured data is received as a batch of data, the current static nonlinearity is identified for the batch of data, and the resultants from identifying the static nonlinearity for the batch of data is compared to previous resultants from identifying the static nonlinearity for a previous batch of data.

4. The method of claim 3, wherein the batch of data is a recoded set of measured data from the operation of the machine.

5. The method of claim 1, wherein identification of the current static nonlinearity includes identification of a data content dependent gain assignment that facilitates an informed decomposition to a realization of the linear plant.

6. The method of claim 1, wherein identification of the current static nonlinearity includes a parametrization of the current static nonlinearity using an orthogonal set of basis functions.

7. The method of claim 3, further comprising:
receiving a second batch of the measured data and the actuator command;
using an estimate of linear dynamics determined from identifying the current static nonlinearity to identify a successive static nonlinearity with the closed loop model structure using the second batch of the measured data and the actuator command.

8. The method of claim 1, wherein the machine is a gas turbine engine.

9. A method for monitoring a condition of a fuel control valve for a fuel system of a gas turbine engine using a closed loop model structure by modeling a static nonlinearity in series between a known fuel control valve and a gas turbine engine linear plant, the method comprising:
receiving a first batch of measured data and fuel control valve commands for the gas turbine engine over a first predetermined time period;
determining a first batch of known fuel control valve outputs from the first batch of fuel control valve commands;
determining a first high order initial parameter set that defines the gas turbine engine linear plant and the static nonlinearity for the first predetermined time period;
determining noise free estimates of the fuel control valve command, the known fuel control valve output, and the system output from the first high order initial parameter set;
determining a fist low order parameter set the defines the gas turbine engine linear plant and the static nonlinearity for the first predetermined time period from the noise free estimates of the known fuel control valve command, the fuel control valve output, and the system output of the gas turbine engine;
receiving a second batch of measured data and fuel control valve commands for the gas turbine engine over a second predetermined time period;
determining a second batch of known fuel control valve outputs from the second batch of fuel control valve commands;
determining a second low order parameter set that defines the static nonlinearity for the second predetermined time period; and
determining whether an effective flow area of the fuel control valve has changed by comparing the second low order parameter set to the first low order parameter set.

10. The method of claim 9, wherein the second low order parameter set is determined using the gas turbine engine linear plant as defined by the first low order parameter set.

11. The method of claim 9, further comprising:
determining a second high order initial parameter set that defines the gas turbine engine linear plant and the static nonlinearity for the second predetermined time period;
determining noise free estimates of the fuel control valve command, the known fuel control valve output, and the system output from the second high order initial parameter set; and
wherein the second low order parameter set is determined from the noise free estimates of the known fuel control valve command, the fuel control valve output, and the system output of the gas turbine engine determined from the second high order initial parameter set.

12. The method of claim 9, wherein first batch of measured data includes a rotational speed of a shaft of the gas turbine engine, a pressure in the gas turbine engine, or a nozzle temperature in the gas turbine engine.

13. The method of claim 9, wherein the first high order parameter set is determined using linear regression techniques.

14. The method of claim 9, further comprising identifying a data content dependent gain assignment that facilitates an informed decomposition to a realization of the gas turbine engine linear plant.

15. The method of claim 9, wherein determining a fist low order parameter set includes a Gaussian basis function parametrization of the static nonlinearity.

16. The method of claim 9, wherein the fuel control valve is monitored remotely.

17. A condition monitoring system for an actuator of a gas turbine engine, the condition monitoring system comprising:
a processor;
an initialization module configured to:
determine a known actuator output from an actuator command determined from a reference input from the gas turbine engine,
determine a high order regressor matrix using the actuator output, and a system output,
determine an initial estimate of a non-minimal parameter of a static nonlinearity modeled in series between the known actuator and a gas turbine engine linear plant within a closed loop model structure from the actuator output and the high order regressor matrix, and
determine an initial estimate of the gas turbine engine linear plant using the initial estimate of the non-minimal parameter;
an estimation module configured to determine noise free estimates of the actuator command, the actuator output, and the system output within the closed loop model structure based on turbine dynamics modeled using a linear error model structure; and
a reduction module configured to:
determine a low order regressor matrix using the noise free estimates of the actuator command, the actuator output, and the system output,
determine a second estimate of the non-minimal parameter using the low order regressor matrix, and
identify the static nonlinearity from the second estimate of the non-minimal parameter.

18. The condition monitoring system of claim 17, wherein the reduction module is configured to compare the identified static nonlinearity to a known static nonlinearity to detect a change in the actuator.

19. The condition monitoring system of claim 18, wherein the actuator is a fuel control valve and the detected change represents contamination within the fuel control valve.

20. The condition monitoring system of claim 17, wherein the condition monitoring system is located remotely to the gas turbine engine.
